(19) United States
(12) Patent Application Publication
(10) Pub. No.: US 2019/0022755 A1
(43) Pub. Date: Jan. 24, 2019

(54) SUPERHARD CONSTRUCTIONS & METHODS OF MAKING SAME

(71) Applicant: Element Six (UK) Limited, Oxfordshire (GB)

(72) Inventors: Nedret CAN, Oxfordshire (GB); David William HARDEMAN, Oxfordshire (GB)

(73) Assignee: Element Six (UK) Limited, Oxfordshire (GB)

(21) Appl. No.: 16/067,150

(22) PCT Filed: Dec. 19, 2016
(86) PCT No.: PCT/EP2016/081683

§ 371 Date: Jun. 29, 2018

(30) Foreign Application Priority Data
Jan. 1, 2016 (GB) 1600001.0

(51) Int. Cl. B22F 3/14; B22F 1/00; B22F 3/11; B22F 7/00; B22F 7/06; C04B 35/52; C22C 29/08

(52) U.S. Cl. CPC B22F 3/14; B22F 1/0014; B22F 1/0022; B22F 3/1103; B22F 2005/001; B22F 7/062; C04B 35/52; C22C 29/08; B22F 7/008

(57) ABSTRACT

A superhard polycrystalline construction comprises a body of polycrystalline superhard material formed of a mass of superhard grains exhibiting inter-granular bonding and defining a plurality of interstitial regions therebetween, and a non-superhard phase at least partially filling a plurality of the interstitial regions and having an associated shape factor of greater than around 0.65 and a substrate bonded to the body of superhard material along an interface, the substrate having a region adjacent the interface comprising binder material in an amount at least 5% less than the remainder of the substrate.

### FIELD

This disclosure relates to superhard constructions and methods of making such constructions, particularly but not exclusively to constructions comprising polycrystalline diamond (PCD) structures attached to a substrate and for use as cutter inserts or elements for drill bits for boring into the earth.

### BACKGROUND

Polycrystalline superhard materials, such as polycrystalline diamond (PCD) and polycrystalline cubic boron nitride (PCBN) may be used in a wide variety of tools for cutting, machining, drilling or degrading hard or abrasive materials such as rock, metal, ceramics, composites and wood-containing materials. In particular, tool inserts in the form of cutting elements comprising PCD material are widely used in drill bits for boring into the earth to extract oil or gas. The working life of superhard tool inserts may be limited by fracture of the superhard material, including by spalling and chipping, or by wear of the tool insert.

Cutting elements such as those for use in rock drill bits or other cutting tools typically have a body in the form of a substrate which has an interface end/surface and a superhard material which forms a cutting layer bonded to the interface surface of the substrate by, for example, a sintering process. The substrate is generally formed of a tungsten carbide-cobalt alloy, sometimes referred to as cemented tungsten carbide and the superhard material layer is typically polycrystalline diamond (PCD), polycrystalline cubic boron nitride (PCBN) or a thermally stable product TSP material such as thermally stable polycrystalline diamond.

Polycrystalline diamond (PCD) is an example of a superhard material (also called a superabrasive material) comprising a mass of substantially inter-grown diamond grains, forming a skeletal mass defining interstices between the diamond grains. PCD material typically comprises at least about 80 volume % of diamond and is conventionally made by subjecting an aggregated mass of diamond grains to an ultra-high pressure of greater than about 5 GPa, and temperature of at least about 1,200° C., for example. A material wholly or partly filling the interstices may be referred to as filler or binder material.

PCD is typically formed in the presence of a sintering aid such as cobalt, which promotes the inter-growth of diamond grains. Suitable sintering aids for PCD are also commonly referred to as a solvent-catalyst material for diamond, owing to their function of dissolving, to some extent, the diamond and catalysing its re-precipitation. A solvent-catalyst for diamond is understood be a material that is capable of promoting the growth of diamond or the direct diamond-to-diamond inter-growth between diamond grains at a pressure and temperature condition at which diamond is thermodynamically stable. Consequently the interstices within the sintered PCD product may be wholly or partially filled with residual solvent-catalyst material. Most typically, PCD is formed on a cobalt-cemented tungsten carbide substrate, which provides a source of cobalt solvent-catalyst for the PCD. Materials that do not promote substantial coherent intergrowth between the diamond grains may themselves form strong bonds with diamond grains, but are not suitable solvent-catalysts for PCD sintering.

Cemented tungsten carbide, which may be used to form a suitable substrate, is formed from carbide particles being dispersed in a cobalt matrix by mixing tungsten carbide particles/grains and cobalt together then heating to solidify. To form the cutting element with a superhard material layer such as PCD or PCBN, diamond particles or grains or CBN grains are placed adjacent the cemented tungsten carbide body in a refractory metal enclosure such as a niobium enclosure and are subjected to high pressure and high temperature so that inter-grain bonding between the diamond grains or CBN grains occurs, forming a polycrystalline diamond or polycrystalline CBN layer.

In some instances, the substrate may be fully cured prior to attachment to the superhard material layer whereas in other cases, the substrate may be green, that is, not fully cured. In the latter case, the substrate may fully cure during the HTHP sintering process. The substrate may be in powder form and may solidify during the sintering process used to sinter the superhard material layer.

Ever increasing drives for improved productivity in the earth boring field create ever increasing demands on the materials used for cutting rock. Specifically, PCD materials with improved abrasion and impact resistance are required to achieve faster cut rates and longer tool life.

Cutting elements for use in rock drilling and other operations require high abrasion resistance and impact resistance. One of the factors limiting the success of the polycrystalline diamond (PCD) abrasive cutters is the generation of heat due to friction between the PCD and the work material. This heat causes the thermal degradation of the diamond layer. The thermal degradation increases the wear rate of the cutter through increased cracking and spalling of the PCD layer as well as back conversion of the diamond to graphite causing increased abrasive wear.

Methods used to improve the abrasion resistance of a PCD composite often result in a decrease in impact resistance of the composite. There is a need for a PCS composite that has improved abrasion resistance and impact resistance and a method of forming such composites.

### SUMMARY

Viewed from a first aspect there is provided a superhard polycrystalline construction comprising:
a body of polycrystalline superhard material formed of:
   a mass of superhard grains exhibiting inter-granular bonding and defining a plurality of interstitial regions therebetween; and
   a non-superhard phase at least partially filling a plurality of the interstitial regions and having an associated shape factor of greater than around 0.65; and
   a substrate bonded to the body of superhard material along an interface, the substrate having a region adjacent the interface comprising binder material in an amount at least 5% less than the remainder of the substrate.

Viewed from a further aspect there is provided a tool comprising the superhard polycrystalline construction defined above, the tool being for cutting, milling, grinding, drilling, earth boring, rock drilling or other abrasive applications.

The tool may comprise, for example, a drill bit for earth boring or rock drilling, a rotary fixed-cutter bit for use in the oil and gas drilling industry, or a rolling cone drill bit, a hole opening tool, an expandable tool, a reamer or other earth boring tools.

Viewed from another aspect there is provided a drill bit or a cutter or a component therefor comprising the superhard polycrystalline construction defined above.

### BRIEF DESCRIPTION OF THE DRAWINGS

Various versions will now be described by way of example and with reference to the accompanying drawings in which:

FIG. 1 is a perspective view of an example of a super hard cutter element or construction for a drill bit for boring into the earth;

FIG. 2 is a schematic cross-section of a portion of a PCD micro-structure with interstices between the inter-bonded diamond grains filled with a non-diamond phase material;

FIG. 3 is a perspective view of a further example of a super hard cutter element or construction for a drill bit for boring into the earth.

### DESCRIPTION

As used herein, a “superhard material” is a material having a Vickers hardness of at least about 28 GPa. Diamond and cubic boron nitride (cBN) material are examples of superhard materials.

As used herein, a “superhard construction” means a construction comprising a body of polycrystalline superhard material. In such a construction, a substrate may be attached thereto or alternatively the body of polycrystalline material may be free-standing and unbacked.

As used herein, polycrystalline diamond (PCD) is a type of polycrystalline superhard (PCS) material comprising a mass of diamond grains, a substantial portion of which are directly inter-bonded with each other and in which the content of diamond is at least about 80 volume percent of the material. In one embodiment of PCD material, interstices between the diamond grains may be at least partly filled with a binder material comprising a catalyst for diamond. As used herein, “interstices” or “interstitial regions” are regions between the diamond grains of PCD material. In embodiments of PCD material, interstices or interstitial regions may be substantially or partially filled with a material other than diamond, or they may be substantially empty. PCD material may comprise at least a region from which catalyst material has been removed from the interstices, leaving interstitial voids between the diamond grains.

As used herein, PCBN (polycrystalline cubic boron nitride) material refers to a type of superhard material comprising grains of cubic boron nitride (cBN) dispersed within a matrix comprising metal or ceramic. PCBN is an example of a superhard material.

A “catalyst material” for a superhard material is capable of promoting the growth or sintering of the superhard material.

The term “substrate” as used herein means any substrate over which the superhard material layer is formed. For example, a “substrate” as used herein may be a transition layer formed over another substrate. Additionally, as used herein, the terms “radial” and “circumferential” and like terms are not meant to limit the feature being described to a perfect circle.

The superhard construction 1 shown in the FIG. 1 may be suitable, for example, for use as a cutter insert for a drill bit for boring into the earth.

Like reference numbers are used to identify like features in all drawings.

As used herein, the term “integrally formed” regions or parts are produced contiguous with each other and are not separated by a different kind of material.

In an example as shown in FIG. 1, a cutting element 1 includes a substrate 3 with a layer of super hard material 2 formed on the substrate 3. The substrate 3 may be formed of a hard material such as cemented tungsten carbide. The super hard material 2 may be, for example, polycrystalline diamond (PCD), or a thermally stable product such as thermally stable PCD (TSP). The cutting element 1 may be mounted into a bit body such as a drag bit body (not shown) and may be suitable, for example, for use as a cutter insert for a drill bit for boring into the earth.

The exposed top surface of the super hard material opposite the substrate forms the cutting face 4, which is the surface which, along with its edge 6, performs the cutting in use.

At one end of the substrate 3 is an interface surface 8 that forms an interface with the super hard material layer 2 which is attached thereto at this interface surface. As shown in FIG. 1, the substrate 3 is generally cylindrical and has a peripheral surface 14 and a peripheral top edge 16.

As used herein, a PCD grade is a PCD material characterised in terms of the volume content and size of diamond grains, the volume content of interstitial regions between the diamond grains and composition of material that may be present within the interstitial regions. A grade of PCD material may be made by a process including providing an aggregate mass of diamond grains having a size distribution suitable for the grade, optionally introducing catalyst material or additive material into the aggregate mass, and subjecting the aggregated mass in the presence of a source of catalyst material for diamond to a pressure and temperature at which diamond is more thermodynamically stable than graphite and at which the catalyst material is molten. Under these conditions, molten catalyst material may infiltrate from the source into the aggregated mass and is likely to promote direct intergrowth between the diamond grains in a process of sintering, to form a PCD structure. The aggregate mass may comprise loose diamond grains or diamond grains held together by a binder material and said diamond grains may be natural or synthesised diamond grains.

Different PCD grades may have different microstructures and different mechanical properties, such as elastic (or Young's) modulus E, modulus of elasticity, transverse rupture strength (TRS), toughness (such as so-called K₁C toughness), hardness, density and coefficient of thermal expansion (CTE). Different PCD grades may also perform differently in use. For example, the wear rate and fracture resistance of different PCD grades may be different.

All of the PCD grades may comprise interstitial regions filled with material comprising cobalt metal, which is an example of catalyst material for diamond.

The PCD structure 2 may comprise one or more PCD grades.

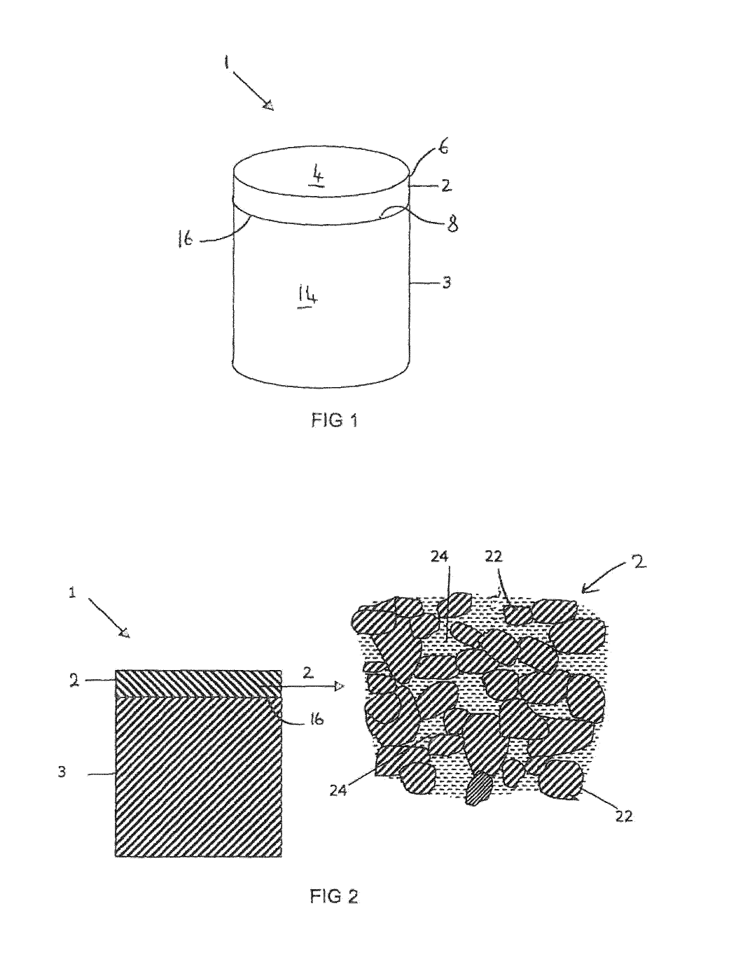

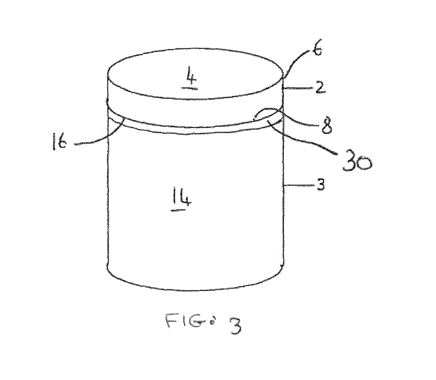

FIG. 2 is a cross-section through a PCD material which may form the super hard layer 2 of FIG. 1. During formation of a polycrystalline diamond construction, the diamond grains 22 are directly interbonded to adjacent grains and the interstices 24 between the grains 22 of super hard material such as diamond grains in the case of PCD, may be at least partly filled with a non-super hard phase material. This non-super hard phase material, also known as a filler material, may comprise residual catalyst/binder material, for example cobalt, nickel or iron. The typical average grain size of the diamond grains 22 is larger than 1 micron and the grain boundaries between adjacent grains is therefore typically between micron-sized diamond grains, as shown in FIG. 2.

Polycrystalline diamond (PCD) is an example of a super hard material (also called a super abrasive material or ultra hard material) comprising a mass of substantially inter-grown diamond grains, forming a skeletal mass defining interstices between the diamond grains. PCD material typically comprises at least about 80 volume % of diamond and is conventionally made by subjecting an aggregated mass of diamond grains to an ultra-high pressure of greater than about 5 GPa, and temperature of at least about 1,200° C., for example. A material wholly or partly filling the interstices may be referred to as filler or binder material.

PCD is typically formed in the presence of a sintering aid such as cobalt, which promotes the inter-growth of diamond grains. Suitable sintering aids for PCD are also commonly referred to as a solvent-catalyst material for diamond, owing to their function of dissolving, to some extent, the diamond and catalysing its re-precipitation. A solvent-catalyst for diamond is understood be a material that is capable of promoting the growth of diamond or the direct diamond-to-diamond inter-growth between diamond grains at a pressure and temperature condition at which diamond is thermodynamically stable. Consequently the interstices within the sintered PCD product may be wholly or partially filled with residual solvent-catalyst material. Materials that do not promote substantial coherent intergrowth between the diamond grains may themselves form strong bonds with diamond grains, but are not suitable solvent-catalysts for PCD sintering.

The grains of superhard material, such as diamond grains or particles in the starting mixture prior to sintering may be, for example, bimodal, that is, the feed comprises a mixture of a coarse fraction of diamond grains and a fine fraction of diamond grains. In some embodiments, the coarse fraction may have, for example, an average particle/grain size ranging from about 10 to 60 microns. By “average particle or grain size” it is meant that the individual particles/grains have a range of sizes with the mean particle/grain size representing the “average”. The average particle/grain size of the fine fraction is less than the size of the coarse fraction, for example between around 1/10 to 6/10 of the size of the coarse fraction, and may, in some examples, range for example between about 0.1 to 20 microns.

In some examples, the weight ratio of the coarse diamond fraction to the fine diamond fraction ranges from about 50% to about 97% coarse diamond and the weight ratio of the fine diamond fraction may be from about 3% to about 50%. In other examples, the weight ratio of the coarse fraction to the fine fraction will range from about 70:30 to about 90:10.

In further examples, the weight ratio of the coarse fraction to the fine fraction may range for example from about 60:40 to about 80:20.

In some examples, the particle size distributions of the coarse and fine fractions do not overlap and in some embodiments the different size components of the compact are separated by an order of magnitude between the separate size fractions making up the multimodal distribution.

The examples may consist of at least a wide bi-modal size distribution between the coarse and fine fractions of superhard material, but some examples may include three or even four or more size modes which may, for example, be separated in size by an order of magnitude, for example, a blend of particle sizes whose average particle size is 20 microns, 2 microns, 200 nm and 20 nm.

In some examples, the average grain size of the aggregated mass of superhard grains is less than or equal to 25 microns. In some examples, the average grain size is between around 8 to 20 microns.

Sizing of diamond particles/grains into fine fraction, coarse fraction, or other sizes in between, may be through known processes such as jet-milling of larger diamond grains and the like.

In examples where the superhard material is polycrystalline diamond material, the diamond grains used to form the polycrystalline diamond material may be natural or synthetic.

With reference to FIG. 3, a further example of a PCD construction is shown in which the PCD layer 2 is integrally joined to a cemented tungsten carbide substrate 3 along an interface surface 16. A denuded zone 30 is present in the substrate adjacent the interface surface 16. In some examples, the denuded zone 30 has a cobalt content of at least 5% less than the cobalt content of the remainder of the substrate 3. In other examples, the denuded zone 30 has a cobalt content of at least 10%, or even at least about 20% less than the cobalt content of the remainder of the substrate 3. This may be measured using conventional techniques such as XRD, SEM or EDF analysis techniques to compare the relative amounts of cobalt in the denuded zone 30 and remainder of the substrate 3.

The denuded zone 30 may have a thickness in the range from about 300 to about 500 microns or, in some examples, up to around 1 mm.

In an example of a PCD element, the PCD structure 2 may be integrally joined to a cemented carbide support body 3 at a non-planar interface 16 opposite the working surface 4 of the PCD structure 2.

The construction and formation of examples of material as shown in FIGS. 1 to 3 are discussed in more detail below with reference to the following example, which is not intended to be limiting.

### Example

Two sets of samples were produced as follows. In a first sample, a multimodal diamond powder mix was prepared comprising a mixture of diamond grains with an average diamond grain size of approximately 15 μm and 1 weight percent cobalt admix, and in a second sample a bimodal diamond powder mix with average grain size of approximately 27 μm was admixed with 1 weight percent cobalt. Each sample was prepared in sufficient quantity to provide approximately 2 g powder per sample. The powder for each sample was then poured into or otherwise arranged in a Niobium inner cup. A cemented carbide substrate of approximately 13 weight percent cobalt content and having a non-planar interface was placed in each inner cup on the powder mix. A titanium cup was placed in turn over this structure and the assembly sealed to produce a canister. The canisters were pre-treated by vacuum outgassing at approximately 1050° C., and divided into two sets which were sintered at distinct ultrahigh pressure and temperature conditions in the diamond-stable region, namely at approximately 6.8 GPa on a belt system (Set 1), and 7.7 GPa on a cubic system (Set 2). Specifically the canisters were sintered at temperatures sufficient to melt the cobalt so as to produce PCD constructions with well-sintered PCD tables and well-bonded substrates. The resulting superhard constructions were not subjected to any post-synthesis leaching treatment.

Image analysis was then conducted on each of these superhard constructions using the techniques described below and in particular to determine the median circularity shape factor of the binder phase in the layer of super hard material 2.

The term shape factor is well known and describes the roundness or edge roughness of an area through a function of the area and the perimeter according to f=4πA/P² where f is the circularity shape factor, A is the pool area and P is the pool perimeter. This quotient provides a range of shape factors such that a perfect circle is 1.

Images used for the image analysis were obtained by means of scanning electron micrographs (SEM) taken using a backscattered electron signal. The back-scatter mode was chosen so as to provide high contrast based on different atomic numbers and to reduce sensitivity to surface damage (as compared with the secondary electron imaging mode).

A number of factors have been identified as being important for image capturing. These are:
SEM Voltage which, for the purposes of the measurements stated herein remained constant and was around 6 kV;
working distance which also remained constant and was around 6 mm;
image sharpness;
sample polishing quality;
image contrast levels which were selected to provide clear separation of the microstructural features;
magnification;
number of images taken.

Given the above conditions, the image analysis software used was able to separate distinguishably the diamond and binder phases and the back-scatter images were taken at approximately 500 μm measured 45° to the cutting edge of the samples.

The magnification used in the image analysis should be selected in such a way that the feature of interest is adequately resolved and described by the available number of pixels. In PCD image analysis various features of different size and distribution are measured simultaneously and it is not practical to use a separate magnification for each feature of interest.

It is difficult to identify the optimum magnification for each feature measurement in the absence of a reference measurement result. A procedure is proposed to be adopted for the analysis of the features of interest. A magnification of 3000 times was chosen for analysis of binder features as it provides a sufficient number of pixels over the smallest features such that accurate image thresholding is possible.

In the image analysis technique, the original image was converted to a greyscale image. The image contrast level was set by ensuring the diamond peak intensity in the grey scale histogram image occurred between 15 and 20 and the bulk binder material peak sits in the range between 145 and 155

For measurements of binder features, the greater the number of images, the more accurate the results are perceived to be. For example, about 15000 measurements were taken, 500 per image with 30 images.

The steps taken by the image analysis programme may be summarised in general as follows:

1. The original image was converted to a greyscale image. The image contrast level was set by ensuring the diamond peak intensity in the grey scale histogram image occurred between 10 and 20 and the binder peak around 145 to 155;
2. An auto threshold feature was used to binarise the image and specifically to obtain clear resolution of the diamond and binder phases;
3. The binder was the primary phase of interest in the current analysis;
4. The software, having the trade name analySIS Pro from Soft Imaging System® GmbH (a trademark of Olympus Soft Imaging Solutions GmbH) was used and excluded from the analysis any particles which touched the boundaries of the image. This required appropriate choice of the image magnification:
a. If too low then resolution of fine particles is reduced.
b. If too high then:
i. Efficiency of coarse grain separation is reduced;
ii. High numbers of coarse grains are cut by the boarders of the image and hence less of these grains are analysed;
iii. Thus more images must be analysed to get a statistically-meaningful result.
   5. Each particle was finally represented by the number of continuous pixels of which it is formed;
   6. The AnalySIS software programme proceeded to detect and analyse each particle in the image. This can be automatically repeated for several images;
   7. A large number of outputs was available. The outputs may be post-processed further, for example using statistical analysis software and/or carrying out further feature analysis, for example the analysis described below for determining the circularity shape factor of the binder areas.

If appropriate thresholding is used, the image analysis technique is unlikely to introduce further errors in measurements which would have a practical effect on the accuracy of those measurements, with the exception of small errors related to the rounding of numbers. In the current analysis, the statistical median values of the total binder area and individual binder areas were used as, according to the Central Limitation Theorem, the distribution of an average tends to be normal as the sample size increases, regardless of the distribution from which the average is taken except when the moments of the parent distribution do not exist. All practical distributions in statistical engineering have defined moments, and thus the Central Limitation Theorem applies in the present case. It was therefore deemed appropriate to use the statistical median values.

The individual non-diamond (e.g. binder or catalyst/solvent) phase areas or pools, which are easily distinguishable from that of the ultrahard phase using electron microscopy, were identified using the above-mentioned standard image analysis tools. Each of these pools was analysed in terms of a shape factor measurement. This circularity factor describes the roundness or edge roughness of an area through a function of the area and the perimeter according to f=4πA/P²

where f is the circularity shape factor, A is the pool area and P is the pool perimeter. This quotient provides a range of shape factors such that a perfect circle is 1.

The collected distributions of this data were then evaluated statistically and an arithmetic average was then determined for each property being considered.

It was determined that the shape factor of the binder pools was greater than 0.65 in some examples for a sintering time of between 6 minutes to 60 minutes. In some example the shape factor was greater than 0.7, or greater than 0.8.

To assist in improving thermal stability of the sintered structure, the catalysing material may be removed from a region of the polycrystalline layer adjacent an exposed surface thereof. Generally, that surface will be on a side of the polycrystalline layer opposite to the substrate and will provide a working surface for the polycrystalline diamond layer. Removal of the catalysing material may be carried out using methods known in the art such as electrolytic etching, and acid leaching and evaporation techniques.

Whilst various embodiments have been described with reference to a number of examples, those skilled in the art will understand that various changes may be made and equivalents may be substituted for elements thereof and that these examples are not intended to limit the particular embodiments disclosed.

1. A superhard polycrystalline construction comprising:
a body of polycrystalline superhard material that comprises:
a mass of superhard grains exhibiting inter-granular bonding and defining a plurality of interstitial regions therebetween;
a non-superhard phase at least partially filling a plurality of the interstitial regions and having an associated shape factor of greater than around 0.65; and
a substrate bonded to the body of superhard material along an interface, the substrate having a region adjacent the interface comprising binder material in an amount at least 5% less than the remainder of the substrate.

2. The superhard polycrystalline construction according to claim 1, wherein the superhard grains comprise natural and/or synthetic diamond grains, the superhard polycrystalline construction forming a polycrystalline diamond construction.

3. The superhard polycrystalline construction according to claim 1, wherein the non-superhard phase comprises a binder phase.

4. (canceled)

5. The superhard polycrystalline construction according to claim 1, wherein the non-superhard phase at least partially filling a plurality of the interstitial regions has an associated shape factor of greater than around 0.7.

6. The superhard polycrystalline construction according to claim 1, wherein the non-superhard phase at least partially filling a plurality of the interstitial regions has an associated shape factor of greater than around 0.8.

7. The superhard polycrystalline construction according to claim 1, wherein the region in the substrate adjacent the interface comprises binder material in an amount at least 10% less than the remainder of the substrate.

8. The superhard polycrystalline construction according to claim 1, wherein the region in the substrate adjacent the interface comprises binder material in an amount at least 20% less than the remainder of the substrate.

9. The superhard polycrystalline construction according to claim 1, wherein the region in the substrate adjacent the interface has a thickness of around 300 to around 600 microns.

10. (canceled)

11. The superhard polycrystalline construction according to claim 3, wherein the binder phase comprises material selected from the group consisting of iron group elements, alloys of iron group elements, carbides, nitrides, borides, and oxides of the metals of Groups IV-VI in the periodic table, and combinations thereof.

12. The superhard polycrystalline construction according to claim 11, wherein the binder phase comprises material selected from the group consisting of iron, iron alloys, cobalt, cobalt alloys, nickel, nickel alloys, carbides, nitrides, borides, and oxides of the metals of Groups IV-VI in the periodic table, and combinations thereof.
